(19) United States
(12) Patent Application Publication
(10) Pub. No.: US 2018/0025799 A1
(43) Pub. Date: Jan. 25, 2018

(54) RADIATION SHIELDING MATERIAL

(71) Applicants: Dong Yong KIM, jeonju-si Jeollabuk-do (KR); Bum Sik HONG, Jeollabuk-do (KR)

(72) Inventors: Dong Yong KIM, Jeonju-si, Jeollabuk-do (KR); Hong Seop SO, Jeonju-si, Jeollabuk-do (KR)

(73) Assignees: Dong Yong KIM, jeonju-si Jeollabuk-do (KR); Bum Sik HONG, Jeollabuk-do (KR)

(21) Appl. No.: 15/546,429

(22) PCT Filed: Jun. 24, 2016
(86) PCT No.: PCT/KR2016/006746

§ 371 Date: Jul. 26, 2017

(30) Foreign Application Priority Data
Sep. 30, 2015 (KR) 10-2015-0137252

(51) Int. Cl. G21F 1/06

(52) U.S. Cl. CPC G21F 1/06

(57) ABSTRACT

The present invention relates to a radiation shielding material. A radiation shielding material containing a lead component, which is used in the related art, has a problem in that the radiation shielding material is harmful to a human body and is heavy in weight. According to the present invention, an airtight container for carrying and storing radioactive waste, or a construction material for shielding radiation, can be made by forming a shielding object in a desired shape by mixing red clay and barley stone with water while stirring the same, firing the shielding object, and attaching carbon fibers to the outer surface of the shielding object by applying lacquer; a shielding material can be configured by making a multi-layer structure by mixing red clay and barley stone with water while stirring the same and then stacking the same on carbon fibers, and forming a lacquer coating layer on the multi-layer structure by forming the surface layer to be a carbon fiber layer; and the wall of a shielding structure can be configured by sequentially forming first and second shielding layers on opposite sides of a concrete layer, wherein the first shielding layer is formed by mixing red clay and barley stone, and the second shielding layer is formed by applying lacquer to carbon fibers.

### TECHNICAL FIELD

The present invention relates to a radiation shielding material, and more particularly, to a radiation shielding material manufacture by using red clay, barley stone, carbon fibers, and lacquer so as to be used as a shielding object for carrying a radioactive waste of a nuclear facility or radiation for medical purposes and a wall or a construction material of a structure for a radioactive waste.

### BACKGROUND ART

A radioactive waste is a radioactive material or a material polluted by the same, which needs to be discarded. The radioactive waste emits radiation. Accordingly, the radioactive waste needs to be isolated for a predetermined time until it does not cause harmful effects on humans.

The radioactive waste is classified into ‘a medium and low level radioactive waste’ and ‘a high level radioactive waste (used nuclear fuel)’ depending on a pollution level. The medium and low level waste is a waste having relatively low radiation content such as working clothes, gloves, and parts that are used at a nuclear power plant or the like, and a radioactive half-life (a period for reducing the number of atoms of a nuclear material in half) thereof is several hours to several years.

In recent years, as nuclear business including a nuclear facility such as a nuclear reactor and a fast breeder, a nuclear fusion facility, or a radiation treatment system for treating an affected part is developed, a material capable of shielding and protecting from radiation harmful to a human body, which is generated from the above-described facilities, is demanded to be developed.

The radiation generated from the facilities is neutron and gamma-rays. Furthermore, since secondary radiation thereof is also harmful to a human body, a shielding material is required to have a capacity to safely protect humans from the radiation.

The neutron and the gamma-rays give great danger to humans and environments. For example, Chernobyl nuclear power plant collapse in Russia (1986) and recent Fukushima nuclear power plant collapse in Japan cause disasters threatening survival of mankind, and preparation for gamma radiation caused by universal hottest region such as Super Solar Storm that was generated in 2012 to 2013 is urgently demanded.

Although a thick lead (Pb) plate is currently used as a shielding material for the gamma-rays, the lead plate is extremely heavy, toxic to humans, and causes harmful effects on environments. Since the neutron and the gamma-rays are different in attenuation characteristics on the basis of each material, combination of various materials is considered as a solution for a shielding material.

When processing into various shapes is necessary, a shielding material made of polyethylene is generally used. Conventionally, a borated polyethylene material in which a boron compound is contained in polyethylene or the like has been used as a neuron shielding material. However, since all borated polyethylene material are imported, the price is unreasonable, and a performance for shielding the gamma-rays is not sufficient. Accordingly, a new shielding material having an excellent performance for shielding radiation and applicable to various fields is demanded to be developed.

In Korean Publication Patent No. 10-2006-0094712 (Aug. 30, 2006), a polyethylene radiation shielding material containing boron and lead for import substitution and a method for manufacturing the same are disclosed. However, it is a problem that the shielding material also contains the lead.

### DISCLOSURE OF THE INVENTION

### Technical Problem

The present invention provides a radiation shielding material without lead that is harmful to a human body.

### Technical Solution

An embodiment of the present invention provides a radiation shielding material for shielding radiation and radioactivity generated from a radiation waste of a medical institution or a radioactive waste of a nuclear facility, the radiation shielding material including:

a first shielding layer molded by mixing red clay and barley stone in water while stirring the same to have a predetermined thickness; and

a second shielding layers 2 in which lacquer is applied to carbon fibers and a plurality of layers of carbon fibers are attached to both surfaces of the first shielding layer.

In an embodiment, the barley stone of the first shielding layer may be pulverized and mixed with the red clay while stirring the same so as to be molded, and, after dried, fired in a heating furnace or a kiln.

In an embodiment, the second shielding layer may be is formed in a plurality of layers in such a manner that the carbon fibers are attached on a surface of the first shielding layer and coated with lacquer, the carbon fibers are attached again on the applied lacquer, and then coated again with the lacquer.

In an embodiment of the present invention, a radiation shielding material according to the present invention includes:

a carbon fiber layer; a first shielding layer formed by mixing red clay and barley stone powder with water while stirring the same so as to be soaked into the carbon fibers and formed to have a predetermined thickness on each of both surfaces thereof; and a lacquer film layer formed in such a manner that a plurality of carbon fiber layers 101 are sequentially laminated to form a multi-layer, the carbon fiber layer 101 is formed on an outermost surface skin layer, and the lacquer film layer 103 is formed by applying lacquer on a surface of the carbon fiber layer 101 of the surface skin layer in a manner of repainting.

In an embodiment, the carbon fiber layer and the first shielding layer may be formed to have a multi-layer structure, molded according to a shape of a shielding object and, after dried, fired in a heating furnace, and then the lacquer film may be formed on the surface skin layer.

In an embodiment of the present invention, a radiation shielding material includes:

a base layer formed of a concrete layer in which a radiation shielding metal oxide is mixed;

a first shielding layer formed by stirring red clay and barley stone in water and applying the same on one surface or both surfaces of the base layer; and

a second shielding layer formed by attaching lacquered carbon fibers to an outer surface of the first shielding layer.

In an embodiment, the radiation shielding material including the concrete layer may be used to constitute a wall of a radiation shielding structure.

In an embodiment, the base layer

may be cured as a single body concrete layer by inserting a plurality of lacquered carbon fibers spaced apart from each other between the concretes in which the radiation shielding metal oxide is mixed.

In an embodiment, the above-described base layer itself, which is formed of the single body concrete layer by inserting a plurality of layers of the lacquered carbon fiber layer in the concretes, may be used as the radiation shielding material.

In an embodiment, the lacquered carbon fiber layer may be attached to both or one of surfaces of the base layer that is the concrete layer.

As described above, the shielding material structures that are different from each other may be appropriately selected and applied in consideration of the kinds of wastes and surround environments and characteristics of a carrying container or a shielding structure.

### Advantageous Effects

The present invention provides a shielding material for shielding the radiation or the radioactivity of the radioactive waste, which are polluted at a medical institution or a nuclear facility. The shielding material may achieve the performance for shielding radiation and radioactivity by forming the first shielding layer formed by mixing and stirring the red clay and the barley stone and the second shielding layer formed of the lacquered carbon fibers on the first shielding layer, have the effects for preventing a damage on the surface of the shielding object or moisture introduced corrosion caused by external environments by virtue of the carbon fibers and the lacquer coating, and be used as the wall of the radiation shielding structure in which the concrete layer is used as the base layer, and the first shielding layer made of the red clay and the barley stone and the second shielding layer formed by using the lacquered carbon fibers are formed on the surface of the base layer.

### BRIEF DESCRIPTION OF THE DRAWINGS

FIG. 1 is a cross-sectional view illustrating a configuration of a radiation shielding material according to the present invention.

FIG. 2 is a cross-sectional view illustrating a configuration of a radiation shielding material according to another embodiment of the present invention.

FIG. 3 is a cross-sectional view illustrating a configuration of a radiation shielding material according to another embodiment of the present invention.

FIG. 4 is a cross-sectional view illustrating a configuration of a radiation shielding material according to another embodiment of the present invention.

FIG. 5 is a cross-sectional view illustrating a configuration of a radiation shielding material according to another embodiment of the present invention.

### MODE FOR CARRYING OUT THE INVENTION

Hereinafter, an embodiment of the present invention will be described with reference to the accompanying drawings.

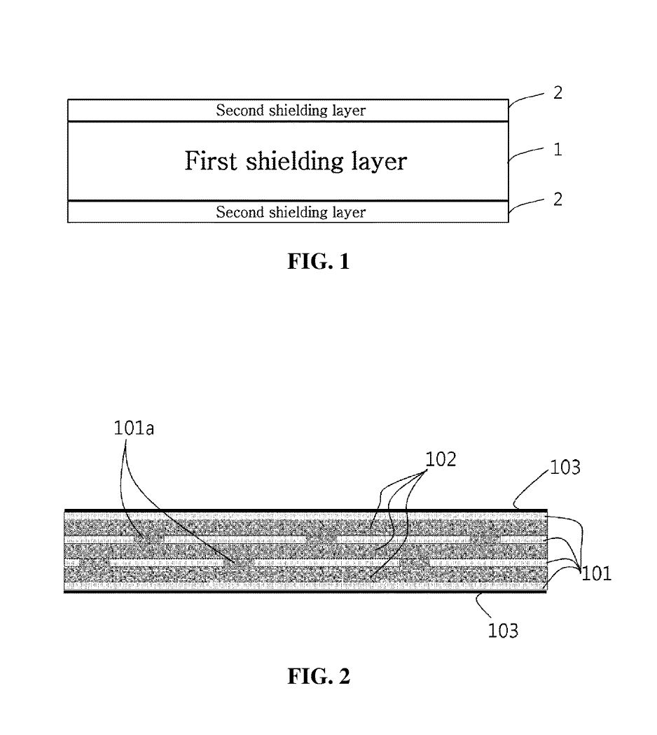

FIG. 1 is a cross-sectional view illustrating a configuration of a radiation shielding material according to the present invention. As illustrated in FIG. 1,

the radiation shielding material is characterized by including a first shielding layer 1 molded in a predetermined thickness by mixing red clay and barley stone with water while stirring the same; and

a second shielding layer 2 formed by applying lacquer to carbon fibers and attaching a plurality of layers of carbon fibers to both surfaces of the first shielding layer 1

According to the present invention, the first shielding layer 1 is molded in a shape of a shielding object by stirring the red clay and the barley stone powder in water.

The barley stone of the first shielding layer 1 is pulverized to be mixed with the red clay while stirring the same. The red clay and barley stone forming the first shielding layer 1 are stirred to be molded, dried, and then fired in a heating furnace or a kiln. Thereafter, the lacquer is applied to the carbon fibers, and the lacquered carbon fibers are attached to both surfaces of the first shielding layer 1 to form the second shielding layer 2.

The second shielding layer 2 that is a plurality of layers of the lacquered carbon fibers is configured in such a manner that a first sheet of carbon fibers is attached to the surface of the first shielding layer 1 and then the lacquer is applied thereto, and a second sheet of carbon fibers is attached on the lacquer and then the lacquer is applied again thereon.

Alternatively, the first shielding layer 1 molded in a process of molding the first shielding layer 1 is completed in such a manner that the red clay and the barley stone are stirred to be molded in a desired shape, then a single layer or a plurality layers of carbon fibers are attached to the both surfaces of the first shielding layer 1 before drying, and, after dried, fired in a heating furnace or the like. The lacquer is applied a plurality of times on the surface of the carbon fibers. Since the lacquer may be burnt at a high temperature, the lacquer may be repainted on the surface after the high temperature firing process is completed.

The red clay is used to be applied on a wall, a floor, or a kitchen furnace as a construction material from old times, used as a raw material for ceramics such as an earthenware or a roof tile, and used to improve a soil of a rice paddy or a field. The red clay includes red clay, alluvial soil, red soil, yellow-red soil, and red-yellow soil. The red clay in a specific district mainly composed of fine sand and contains a large amount of calcium carbonate to have viscosity enough not to be easily pulverized.

When water is added, the red clay is changed into clay. Furthermore, since the red clay contains quartz, feldspar, mica, as calcite, the quartz, the feldspar, the mica, and the calcite and causes oxidation together with iron, the red clay may have a color of red, purple, red, or gray.

Since the red clay that is considered as the best among soils has the nature of a drug such as a resolution property, a magnetic field property, and an absorption property, the red clay has effects including a moisture adjusting function, a temperature maintaining function, electromagnetic wave absorption, far-infrared radiation, and physiological function activation. (source: Digital local culture encyclopedia of Korea, The academy of Korean studies)

The present invention uses the electromagnetic wave absorption effect among the above-described effects of the red clay. The present invention achieves a function of shielding electromagnetic wave and radiation by using the electromagnetic wave absorption effect.

Also, since the barley stone has multi-layer pores of 30,000 to 150,000 per 1 cm³ to have a wide specific surface area, the barley stone acts to adsorb and decompose pollutants, heavy metal, or the like, and has effects such as cement poison neutralization, an antibacterial property, an insect-proof property, and a strong deodorization property. In recent years, a technique for removing dioxin is disclosed by Yonam institute of technology. Also, due to resonance, resonation, and absorption caused by far-infrared radiation, the barley stone is used for a food container and has an electromagnetic wave shielding function.

The present invention achieves the electromagnetic wave shielding function and the radiation shielding function by utilizing the heavy metal adsorption and decomposition effects due to the multi-layer porous material of the barley stone and the resonance, resonation, absorption, and electromagnetic wave shielding function caused by far-infrared radiation.

As the first shielding layer 1 is formed by mixing the red clay and the barley stone, which have the above-described functions, in water while stirring the same, the first shielding layer 1 itself has effects as the radiation shielding material.

Also, the second shielding layer 2 is formed in a plurality of layers by applying the lacquer to the carbon fibers and attaching the same to an outer surface of the first shielding layer 1.

The carbon fibers are less in weight by one-fourth, greater in strength by ten times, and greater in elastic modulus by seven times than steel. Also, since the carbon fibers are high intensity and elastic cutting-edge materials having excellent impact resistance and thermal resistance, the carbon fibers have been used as a core material of a high-value composite material for aviation, aerospace, a defense industry, and a semiconductor. Most of the carbon fibers are used as a composite reinforcement material for a structural material. Especially, high performance carbon fibers are mostly used as carbon fiber-reinforced plastics (CFRP) for a basic material of an epoxy resin. In addition, the carbon fibers are used for an reinforcement material for a composite having a basic material of thermoplastic resin, copper, aluminum or magnesium-based alloy, carbon (carbon-carbon composite), and cement concrete. [Naves knowledge encyclopedia] carbon fibers (High tech technology dictionary, May 1, 1992, Gyeomiji corporation)

The present invention uses the above-described characteristics of the carbon fibers. The second shielding layer 2 is formed as a carbon fiber composite material by applying the lacquer to the carbon fibers. The plurality of layers may be formed in such a manner that the lacquer is applied to the carbon fibers, then the carbon fibers are attached again thereon, and the lacquer is applied. The lacquer application method may include a method of putting the carbon fibers in a lacquer solution so as to be soaked therein and then attaching, a method of applying the lacquer by using a conventional brush, or a method of spraying the lacquer solution. As described above, the lacquer application method may be varied as necessary.

Since the carbon fibers are fundamentally coupling structures of carbon molecules, the carbon fibers have a function of shielding a radioactive material or an electromagnetic wave, and the lacquer is used as one of raw materials for a stealth paint that is applied to a stealth group and has the function of shielding an electromagnetic wave. Accordingly, the second shielding layer 2 in which the lacquer is applied to the carbon fibers may have the function of shielding the electromagnetic wave and the radiation and protect the first shielding layer 1 disposed inside the second shielding layer 2 without damaging the shape of the first shielding layer 1 in virtue of advantages such as the light weight, high strength, high elasticity, impact resistance, and thermal resistance of the carbon fibers. Since the lacquer has an excellent corrosion resistance and prevents moisture from being introduced, the first shielding layer 1 may be prevented from being damaged and naturally decomposed to maintain a long life span.

Accordingly, as described above, the present invention may provide an airtight container formed by the first and second shielding layers 1 and 2 so as to be used as an airtight container for a waste disposal facility and for carrying, storing, and processing wastes, e.g., secondary radioactive wastes such as a medical radioactive waste and gloves or clothes used at a nuclear power plant or used as a container for carrying a radioactive waste. Also, the present invention may provide a radiation shielding plate to be used as a construction material, and more particularly, to be used as a construction material for shielding radiation at an area generating radon, e.g., a subway station.

FIG. 2 is a cross-sectional view illustrating a configuration of the radiation shielding material according to another embodiment of the present invention.

As illustrated in FIG. 2, the radiation shielding material includes: a carbon fiber layer 101; a first shielding layer 102 in which red clay and barley stone powder are mixed and stirred in water and soaked into the carbon fibers to form a predetermined thickness on both surfaces thereof; and a lacquer film layer 103 in which the carbon fiber layer 101 and the first shielding layer 102 are sequentially laminated in a plurality of layers, the carbon fiber layer 101 is formed on an outermost surface skin layer, and the lacquer is reapplied on the surface of the carbon fiber layer 101 of the surface skin layer.

As described above, the carbon fiber layer 101 has a multi-layer structure in which the plurality of carbon fibers are laminated. When the red clay and the barley stone powder are stirred in the water and applied again to top and bottom surfaces of the carbon fiber layer 101 having the multi-layer structure, the red clay and the barley stone powder are soaked into the carbon fibers to form the first shielding layer 102 having a predetermined thickness on the top and bottom surfaces of the carbon fiber layer 101. Through the above-described method, the carbon fiber layer 101 and the first shielding layer 102 in which the red clay and the barley stone are stirred are laminated in the multi-layer structure, and the carbon fiber layer 101 is provided on the both surfaces of the first shielding layer 102 to mold in a desired shape. The radiation shielding material is dried after molded and fired in a heating furnace. Thereafter, the lacquer solution is applied several times on the surface of the carbon fiber layer 101 to form the lacquer film layer 103.

Here, as a plurality of connection holes 101a are defined in the carbon fiber layer 101, the carbon fiber layer 101 is inserted into the first shielding layer 102 in which the red clay and the barley stone are mixed, so that the first shielding layer 102 and the carbon fiber layer 101 are connected to and integrated with each other. Alternatively, the carbon fiber layer 101 inserted into the first shielding layer 102 in which the red clay and the barley stone are mixed may be formed in a mesh shape having a plurality of through-holes to improve a structural strength.

As described above, the carbon fiber layer 101 and the first shielding layer 102 that is a mixture of the red clay and the barley stone may be formed to manufacture a barrel or box shaped airtight container capable of sealing by closing a cap, the airtight container may be fired in a heating furnace so as to be manufactured as a desired carrying container, a storage container, a shielding object, or a shielding wall for a radioactive waste, and the lacquer is applied again to the carbon fiber layer 101 forming inner and outer surfaces, i.e., surfaces of the fired shielding object to form the lacquer film 103, thereby completing the shielding object.

Accordingly, the radiation and the radioactivity may be shielded by the lamination structure of the red clay, the barley stone and the carbon fibers, and since moisture introduced from the outside and corrosion may be prevented in virtue of the lacquer film on the surface, the shielding object may be used for a container for accommodating and carrying a radioactive waste used in a medical institution or a radiation waste of a nuclear power plant or a container for storing the same.

Meanwhile, in case of a wall of the radiation shielding structure, the structure formed by only the first shielding layer 1 and the second shielding layer 2 may not be appropriate to be the wall of the structure because it is limited to be thick in thickness. In consideration of this, the present invention provides another embodiment in which a concrete layer is provided therebetween as a base layer.

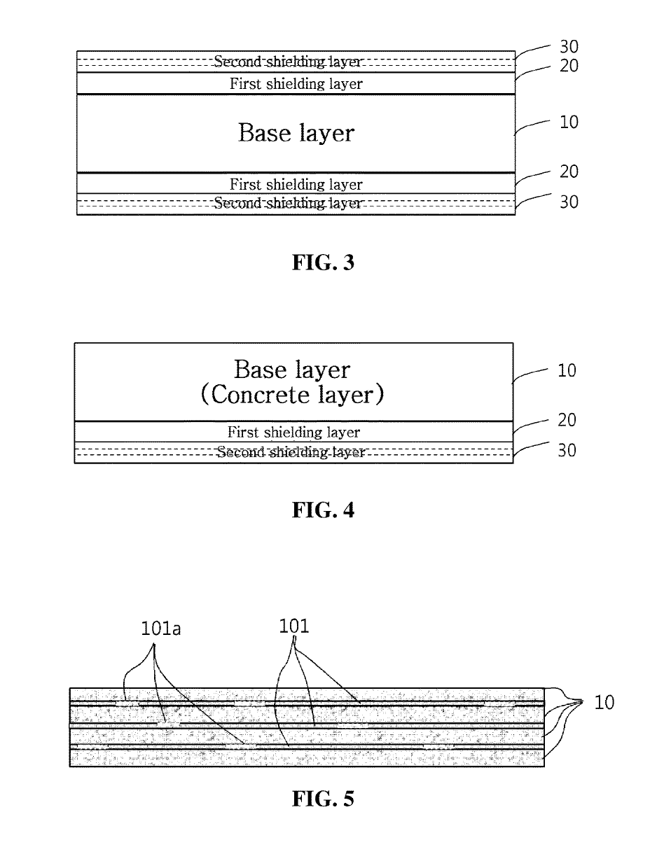

FIG. 3 is a cross-sectional view illustrating a configuration of a radiation shielding material according to another embodiment of the present invention. As illustrated in FIG. 3,

the radiation shielding material includes: a base layer 10 formed by a concrete layer in which a radiation shielding metal oxide is mixed;

a first shielding layer 20 in which red clay and barley stone are stirred in water and applied on both surfaces of the base layer; and

a second shielding layer 30 in which carbon fibers to which lacquer is applied are attached to an outer surface of the first shielding layer 20.

The second shielding layer 30 has a multi-layer structure of the lacquered carbon fibers.

Here, the concrete layer forming the base layer 10 is generally a steel reinforced concrete structure to reinforce a structural strength in case of a large structure or a concrete layer in which a steel reinforced mesh such as a wire gauze is inserted. In description of the present invention, the layer is described as the concrete layer for convenience.

The above-described another embodiment of the present invention has a structure in which the concrete layer in which the metal oxide for shielding radiation is mixed is provided as the base layer 10, the red clay and the barley stone powder are mixed in water while stirring the same and applied on the both surfaces of the base layer 10 to form the first shielding layer 20, and a plurality of layers of the lacquered carbon fibers are formed on both outer surfaces of the first shielding layer 20 to form the second shielding layer. Here, the radiation shielding metal oxide may use one or more kinds of metal oxide selected from the group consisting of Bi₂O₃, WO₃ and Gd₂O₃.

As generally known, the concrete layer that is the base layer 10 is generally used as a shielding material for neutron and gamma-rays. The present invention may provide the shielding material capable of shielding all radiation from high level to low level by forming in such a manner that the first shielding layer 20 in which the red clay and the barley stone are mixed is formed on the outer surface of the base layer 10 that is the concrete layer, and the second layer 30 having the multi-layer structure of the lacquered carbon fibers is formed on the outer surface of the first shielding layer 20.

Also, since the second shielding layer 30 that is the innermost or outermost surface is formed of the lacquered carbon fiber layer, the radiation shielding material may be suitable for an indoor structure.

FIG. 4 is a cross-sectional view illustrating a configuration of a radiation shielding material according to another embodiment of the present invention. As illustrated in FIG. 4,

the radiation shielding material includes: a base layer 10 formed of a concrete layer in which a radiation shielding metal oxide is mixed;

a first shielding layer 20 in which red clay and barley stone are stirred in water and applied on one surface of the base layer 10; and

a second shielding layer 30 in which the lacquered carbon fibers are attached to an outer surface of the first shielding layer 20.

That is, the first shielding layer 20 and the second shielding layer 30 are sequentially attached on one surface of the base layer 10 formed of the concrete layer. In consideration of characteristics or an installation environment of the radiation shielding structure, the red clay and barley stone stirred shielding layer and the carbon fiber shielding layer are laminated on only one surface of the concrete layer. Here, the concrete layer has a steel reinforced concrete structure or a wire mesh concrete structure depending on the structural characteristics thereof.

Although not shown in the drawings, the second shielding layer 30, i.e., the shielding layer made of the lacquered carbon fibers, is formed on both or one of the surfaces of the base layer 10 formed of the concrete layer. Here, the shielding layer formed of the lacquered carbon fibers has a multi-layer structure.

FIG. 5 is a cross-sectional view illustrating a configuration of a radiation shielding material according to another embodiment of the present invention. As illustrated in FIG. 5,

a carbon fiber layer 101 formed by applying lacquer to a plurality of carbon fibers is inserted into a concrete layer 10 containing the radiation shielding metal oxide to form an integral-type base layer 10.

That is, the plurality of carbon fiber layers are inserted into the concrete layers to cure the concrete layer. As a plurality of connection holes 101a are defined in the carbon fiber layer 101 inside the concrete layer, the concrete layers are cured to be a single body. Although not shown in the drawing, the concrete layer has a steel reinforced concrete or a wire mesh concrete structure depending on structural characteristics, and the plurality of lacquered carbon fiber layers are inserted therein.

Thus, the above-described structure may be used to manufacture a concrete drum for carrying and storing a waste or a concrete layer, in which the carbon fiber layer is inserted into the concrete, for an outer wall of a cave at a cave-type radiation waste storage facilities.

What is claimed is:

1. A radiation shielding material for shielding radiation and radioactivity generated from a radiation waste of a medical institution or a radioactive waste of a nuclear facility, the radiation shielding material comprising:
a first shielding layer (1) molded by mixing red clay and barley stone in water while stirring the same to have a predetermined thickness; and
a second shielding layers (2) in which lacquer is applied to carbon fibers and a plurality of layers of carbon fibers are attached to both surfaces of the first shielding layer (1).

2. The radiation shielding material of claim 1, wherein the barley stone of the first shielding layer (1) is pulverized and mixed with the red clay while stirring the same so as to be molded, and, after dried, fired in a heating furnace or a kiln.

3. The radiation shielding material of claim 1, wherein the second shielding layer (2) is formed in a plurality of layers in such a manner that the carbon fibers are attached on a surface of the first shielding layer (1) and coated with lacquer, the carbon fibers are attached again on the applied lacquer, and then coated again with the lacquer.

4. A radiation shielding material for shielding radiation and radioactivity generated from a radiation waste of a medical institution or a radioactive waste of a nuclear facility, the radiation shielding material comprising: a carbon fiber layer (101); a first shielding layer (102) formed by mixing red clay and barley stone powder with water while stirring the same so as to be soaked into the carbon fibers and formed to have a predetermined thickness on each of both surfaces thereof; and a lacquer film layer (103) formed in such a manner that a plurality of carbon fiber layers 101 are sequentially laminated to form a multi-layer, the carbon fiber layer 101 is formed on an outermost surface skin layer, and the lacquer film layer (103) is formed by applying lacquer on a surface of the carbon fiber layer (101) of the surface skin layer in a manner of repainting.

5. The radiation shielding material of claim 4, wherein the carbon fiber layer (101) and the first shielding layer (102) are formed to have a multi-layer structure, molded according to a shape of a shielding object and, after dried, fired in a heating furnace, and then the lacquer film (103) is formed on the surface skin layer.

6. A radiation shielding material comprising:
a base layer (10) formed of a concrete layer in which a radiation shielding metal oxide is mixed;
a first shielding layer (20) formed by stirring red clay and barley stone in water and applying the same on one surface or both surfaces of the base layer (10); and
a second shielding layer (30) formed by attaching lacquered carbon fibers to an outer surface of the first shielding layer (20).

7. The radiation shielding material of claim 6, wherein the base layer (10) is cured as a single body concrete layer by inserting a plurality of lacquered carbon fibers spaced apart from each other between the concretes in which the radiation shielding metal oxide is mixed.

8. A radiation shielding material that is cured as a single body concrete layer by inserting a plurality of lacquered carbon fibers spaced apart from each other between concretes in which a radiation shielding metal oxide is mixed.

9. A radiation shielding material comprising:
a base layer (10) formed of a concrete layer in which a radiation shielding metal oxide is mixed; and
a second shielding layer (30) formed by multi-laminating lacquered carbon fibers on both or one of outer surfaces of the base layer (10)
